(19) United States
(12) Patent Application Publication
(10) Pub. No.: US 2003/0061022 A1
(43) Pub. Date: Mar. 27, 2003

(54) Display of translations in an interleaved fashion with variable spacing

(76) Inventor: James R. Reinders, Portland, OR (US)

Correspondence Address: James H. Salter, Blakely, Sokoloff, Taylor & Zafman LLP, Seventh Floor, 12400 Wilshire Boulevard, Los Angeles, CA, 90025-1030, US

(21) Appl. No.: 09/962,721

(22) Filed: Sep. 21, 2001

(51) Int. Cl. G06F 17/28

(52) U.S. Cl. 704/2

(57) ABSTRACT

A method to display a language translation includes displaying a word of a first language on an information display and displaying a first translation of the word of the first language into a second language proximate to the word of the first language. A second translation of the word of the first language into the second language may be displayed beneath the first translation of the word of the first language. The first translation of the word is displayed in a first color, which is different from a color used to display the word.

### BACKGROUND OF THE INVENTION

1. Field of Invention

This invention relates generally to information displays and more specifically to displaying a word of a language and the translation of the word of the language in an interleaved fashion.

2. Background

Existing software translators are difficult for a user who is not familiar or fluent in the language of the input document or the language of the translation to use. Output from such a translator typically results in the entire input document being translated into the language of the translation. Users who are fluent in the language of the translation may then read the translated document relying on their knowledge of the translated language. A user who is not familiar with the language of the translation is not assisted by this type of translation format to learn or understand the language of the translation. Conversely, a user who is not fluent in the language of the input document is not assisted to learn or understand the language of the input document. Neither does the format of existing language translators provide user interaction with the translation process to thereby improve the accuracy of the translation.

The number of users of existing language translators is limited due to the shortcomings mentioned above. A novice reader of either the input language or the language of the translation is rendered incapable of reading either the input document or the translated document. What is needed is a way of helping a user who is not familiar with either the language of the input document or the translated language read and understand either the input document or the translation of the input document into the translated language. What is also needed is a way of allowing a user to interact with the translation process in order to improve the accuracy of the translation by applying the context in which the language is used.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The present invention is illustrated by way of example and is not limited in the figures of the accompanying drawings, in which like references indicate similar elements.

FIG. 1 illustrates an interleaved display of a word and a translation of the word.

FIG. 2 illustrates a line of input words and the corresponding output translation.

FIG. 3 shows an application of the invention to a handheld computer with dynamic display functionality.

FIG. 4 illustrates using color to indicate a preferred translation.

FIG. 5 illustrates an application of the invention to a handheld computer with multiple interleaved translation results in the Italian language.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

Methods and apparatuses are disclosed to enable a user to view a portion of a first language (an input) and a translation of the input into a second language (an output), displayed in an interleaved format. Use herein of the term “portion of a first language” is broad encompassing a word, a phrase, a sentence, a value (expressed as a monetary unit using numerals) or any part or combination thereof. For simplicity in describing the present invention, use herein of the term “input” may be used interchangeably with the term “word”, “word of the first language”, or “portion of a first language.” Similarly, the use herein of the term “output” may be interchangeable with the term “translation” or “translation of the word into a second language.” The present invention is not limited by the choice of the term used to describe the input, output or portion thereof.

The interleaved format of the display requires that the input and output be displayed proximate to each other in time and space. Thus, the term “interleaved” and the term “proximate” may be used interchangeably with reference to the present invention. Display of the input word and output translation in the interleaved format provides a translation of language and a teaching tool for associating the input word, the translated language, and the context of use to a user that is inexperienced in the translated language or the language of the input word.

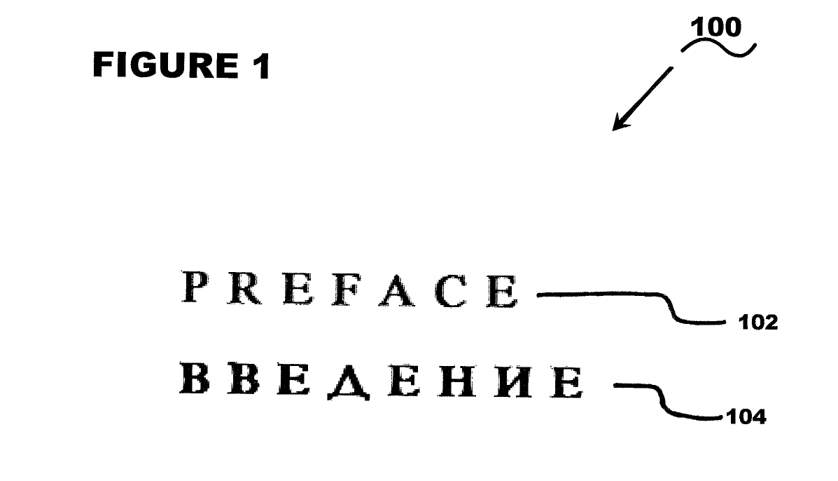

In one embodiment of the present invention, FIG. 1 illustrates an interleaved display 100 of a word and a translation of the word according to the present invention. With reference to FIG. 1 a word of a first language is shown at 102 in English, the word is “preface.” The translation of 102 into a second language, Russian, is shown at 104 in the color blue which is a different color than that used to display the input 102. An interleaved display 100 implies proximity in time and space between the word 102 and the translation 104. A close spatial association conveys to the reader that 104 is the translation of 102. “Proximate” may be manifested differently according to various embodiments of the invention.

For example, in the embodiment shown in FIG. 1 the translation 104 is displayed beneath the input 102. Left-right alignment resulting in a substantially centered appearance of the output 104 relative to the input 102 is illustrated at 100. The illustration of FIG. 1 may be desired when applied to languages that are read from left to right.

In another embodiment (not shown) the output 104 may be displayed above the input 102. Such an alternative representation may be desirable when other languages are being translated which read from right to left. The ordering of the input and output may be user selectable so that the user may configure the display according to personal preference. Thus, “proximate” may be tailored to the individual preference of the user.

In yet another embodiment (not shown), where a language is read from top to bottom, in a column, the output may be displayed to the right or left of the input. Such an orientation may be desirable when a translation is being made into an Asian language. The invention is not limited to a precise placement of the output relative to the input. The interleaved format of the display encompasses any orientation that produces proximity in time and space between the input word and the output translation of the word into the translated language.

Display of the word and the translated word may be a dynamic process in which a continuous flow of words follows each other to form lines of text and numbers. Successive lines and numbers are added to fill a page of text and then the page scrolls in a direction, such as up or down, as new lines are added to the bottom of the page. The dynamic display format provides a tight coupling between the input word and the output translation of the word in a text stream, as the document to be translated is dynamically displayed on an information display.

The document to be translated may be translated according to any of the methods that are well known in the art. In one example, a document may be scanned, a word, a page, or a line at a time and subsequently converted into electronic format. The electronic format may then be translated to form the output translation of the word. The input word and the translation of the input word are then displayed in the interleaved format previously described. Many types of scanners are well known in the art, as are language translators and may be used in conjunction with the present invention.

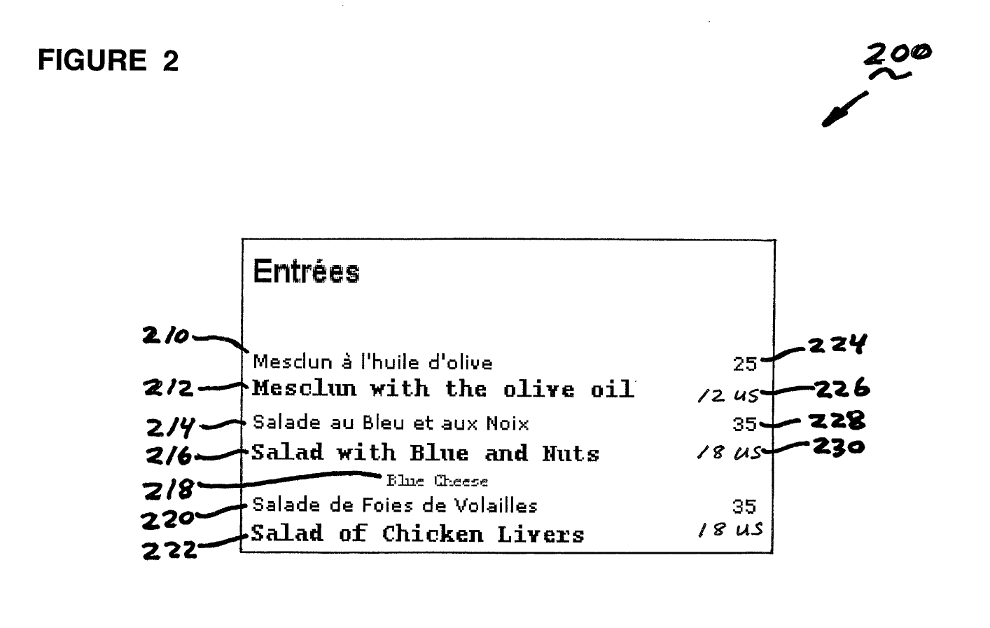

As was previously mentioned, in one embodiment, multiple words may be displayed on a line. FIG. 2 illustrates lines of input words and the corresponding output translations. With reference to FIG. 2, a plurality of lines of input words and output translations are shown in 200. A line of input words 210 is displayed for a menu entrée in a restaurant with a numeric price 224. Beneath 210 is the corresponding output translation 212 with a corresponding translated price 226. In the example of 200 the interleaved format can be seen by the location of 212 beneath 210.

The desired proximity between the input word and the output translation can be achieved at multiple levels within the teaching of the invention. The example of FIG. 1 illustrates a word-by-word implementation of proximity as previously described. At one level, the example of FIG. 2 illustrates a line-by-line implementation of proximity and the word-by-word implementation of proximity as illustrated in FIG. 1. With reference back to FIG. 2, information is imparted to the user based on the proximity of the translation to the input, where line 212 is displayed directly below 210. Information is also imparted to the user based on the proximity of each word in 212 relative to each word in 210. Numerical input such as the price of the entrée indicated by 210 is shown at 224 and the associated translation of 224 is shown at 226. 224 to 226 illustrates an example of value (price) expressed with numerals as a currency translated according to the teaching of the present invention.

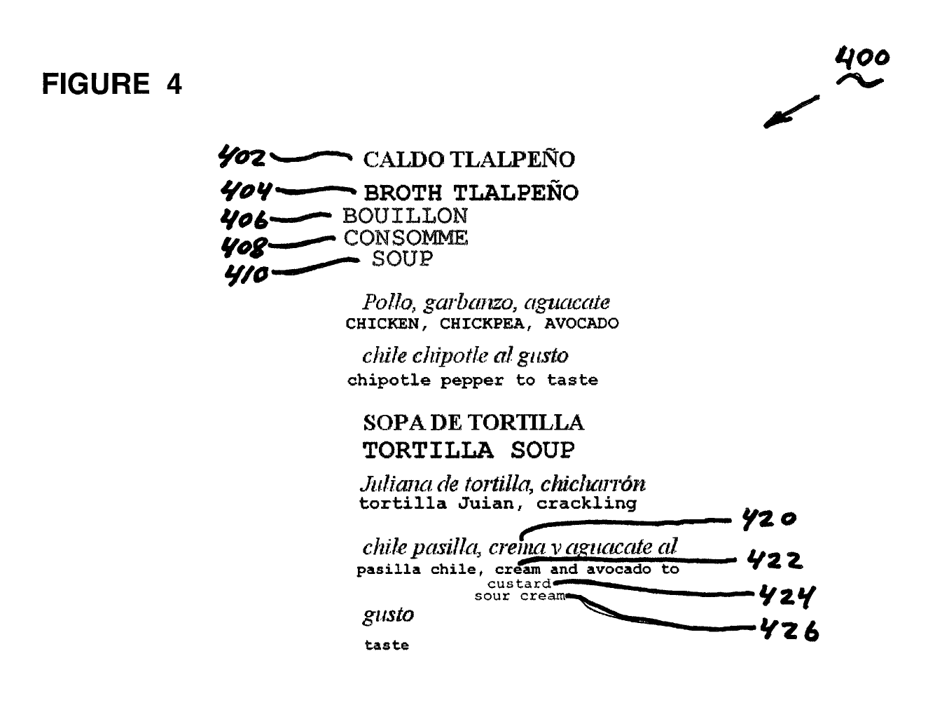

Similarly, input 214 is translated as output 216. In one embodiment, a translation of a word may not produce a unique result but may return several possible translations. An example of the interleaved display according to the present invention for displaying this variation is shown at 218. In this example a secondary translation 218 is displayed below the primary translation 216. “Blue Cheese” at 218 is displayed beneath the word “Blue” in 216 to convey the tight coupling inherent in the meaning of “proximity” as taught by the present invention and applied between input and output. The idea of plural translation choices being displayed proximate to the input word will be developed more fully in conjunction with FIG. 4 below.

The interleaved format of the display teaches the user the correspondence between translation of the input word into the output translation language. Observation of 220 and 222 conveys to the user that “Foies de Volailles” is translated to “Chicken Livers”. “Volailles” is translated as “Chicken” and “Foies” is translated as “Liver” which illustrates and teaches sentence restructuring appropriate to the output translation language (in this case, how adjectives proceed or follow the word they modify). A user need not be familiar with the language of the input in order to begin to understand the input language in light of the translation. Proximity can encompass additional queues on the word-to-word translation according to the teaching of the present invention. An example of such a que would be to draw a line from “Foies” to “Livers.” Proximity can be accomplished by other associations, such as coloring words to match each other.

Input sentence 220 and output translation 222 is shown as the last line in 200. The lines of 200 may be displayed in a scrolling fashion as previously described where successive lines are displayed at the bottom and previously displayed lines move up on an information display. In another embodiment the opposite loading is possible with the new line being added at the top and the previously displayed line moving down the information display.

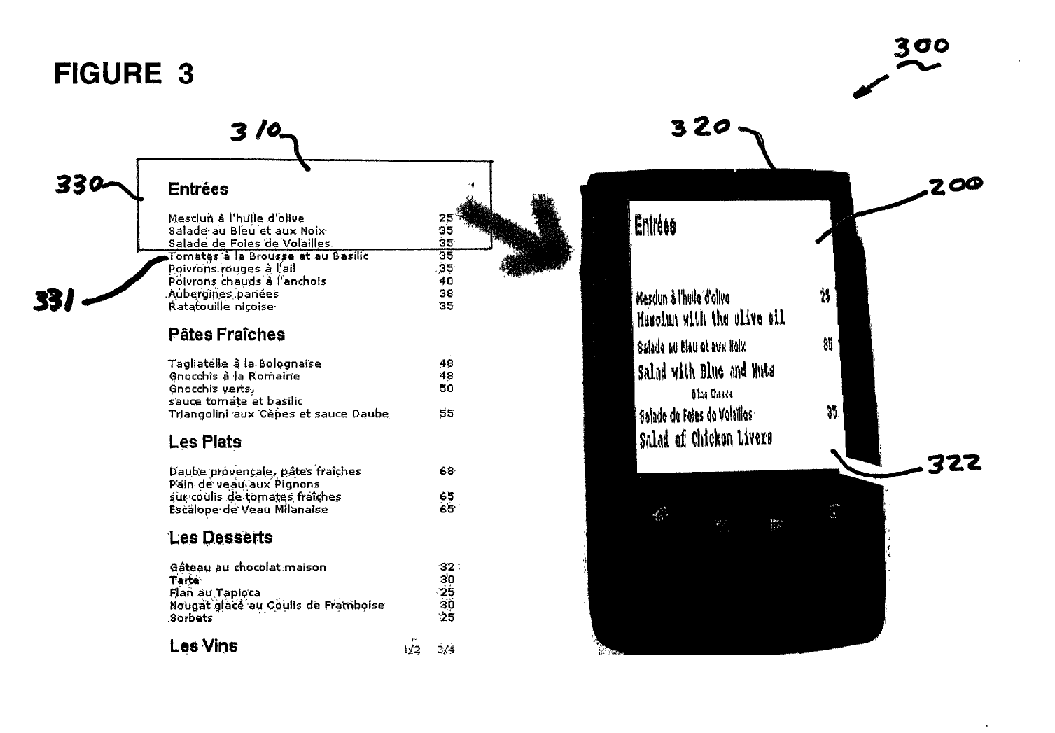

The dynamic operation of the present invention can be illustrated more fully with respect to FIG. 3. In one embodiment, FIG. 3 shows an application of the present invention to a handheld computer with dynamic display functionality. With reference to FIG. 3, the plurality of lines of input words and output translations shown in 200 of FIG. 2 is placed within an information display of a handheld computer. The correspondence between input words and output translation on an information display is shown at 300. In this example, a French menu 310 is being translated into English and is displayed in the interleaved fashion on information display 322 of handheld computer 320. A portion 330 of the French menu 310 corresponds with the input lines and output translations shown in 200.

Dynamic operation of the present invention is achieved as the view presented within the information display 322 is shifted down the page of the French menu 310. As the view shifts down the French menu, the next line 331 of the French menu 310 beneath the box associated with 330 will be displayed on 322 and the top line, containing the word “Entrees,” will be removed from view. The translation associated with the next line 331 of the French menu will be displayed in the interleaved format as previously described.

A translation of a word may return a plurality of possible translations, as previously mentioned. FIG. 4 illustrates using color to indicate a preferred translation from a plurality of possible translations. With reference to FIG. 4, a plurality of input sentences and the corresponding translation are shown at 400. An input phrase in a first language, Spanish, “CALDO TLALPENO” is shown at 400. The translation of this phrase into a second language, English, is shown at 404 as “BROTH TLALPENO.” The word “BROTH” in 404 has produced a plurality of translations. In one embodiment, the primary translation for “CALDO,” which is “BROTH” is displayed in the color blue. Additional secondary translations are displayed in the color red. Secondary translations for “CALDO” are “BOUILLON” at 406, “CONSUMME” at 408, and “SOUP” at 410. Additional confidence in the translations may be conveyed to the user by the proximity of the secondary translations relative to the primary translation 404. Thus, the translation confidence of 406 is greater than the translation confidence associated with 408 because 408 is located a greater distance away from 404 than 406 is located from 404. According to this embodiment, decreasing proximity is conveying decreasing translation confidence. Another example is presented with the Spanish word “crema” at 420. “Crema” produces a primary translation in English as “cream” at 422. Secondary translations are “custard” at 424 and “sour cream” at 426.

The user may select from the possible translations presented (primary and one or more secondary translations) based on the context of use to assist the translation accuracy. Lines on the information display will scroll up, as all but the selected translation remains on the information display. Operation according this embodiment allows more interleaved lines of text to be displayed on the information display subsequent to the selection of the translation choice by the user.

In another embodiment (not shown) decreasing translation confidence may be communicated to the user by displaying the secondary translations in different colors. In one example, decreasing shades of color intensity along a spectrum, red fading to pink, indicate decreasing translation confidence. In another embodiment the same shade of a color may indicate the same level of translation confidence, therefore in this embodiment the 424 and the 426 translations would possess the same translation confidence. Those of skill in the art will note that the present invention is not limited by the color chosen for display. It is contemplated that the use of color to convey translation accuracy will be manifest in many and varied embodiments according to the teachings of the present invention.

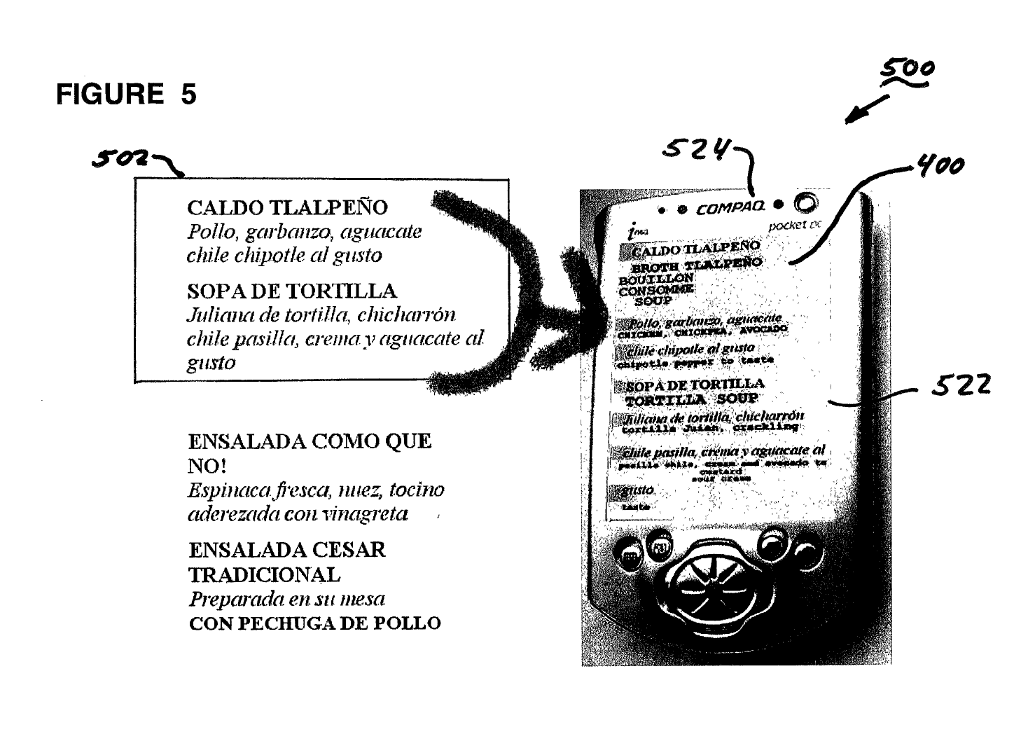

In one embodiment, FIG. 5 illustrates an application of the present invention to a handheld information display 522 with multiple interleaved translation results 400. With reference to FIG. 5, a portion of an Italian menu 502 produces a translation resulting in the plurality of input sentences and the corresponding translations 400 displayed on the handheld information display 522. The handheld information display 522 may be part of a data processing system, such as a computer system. In one embodiment, the multiple interleaved translation results 400 could be displayed on a handheld computer. In one embodiment, 524 is a handheld computer.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

Thus, a novel method and apparatus for displaying a word of a language and the translation of the word of the language in an interleaved fashion is described. Although the invention is described herein with reference to specific preferred embodiments, many modifications therein will readily occur to those of ordinary skill in the art. Accordingly, all such variations and modifications are included within the intended scope of the invention as defined by the following claims.

What is claimed is:

1. A method to display language translation, comprising:
displaying a word of a first language on an information display; and
displaying on the information display, a first translation of the word of the first language into a second language proximate to the word of the first language, wherein the first translation of the word is displayed in a first color which is different from a color used to display the word.

2. Said method of claim 1, wherein the first translation of the word into the second language is displayed beneath the word of the first language.

3. Said method of claim 1, wherein the first translation of the word into the second language is displayed above the word of the first language.

4. Said method of claim 1, a second translation of the word of the first language into the second language displayed beneath the first translation of the word of the first language.

5. Said method of claim 4, wherein the second translation of the word is displayed in a second color chosen to indicate a lower probability of translation accuracy than achieved with the first translation.

6. Said method of claim 4, further comprising:
selecting between the first translation and the second translation of the word, wherein only a translation selected remains displayed.

7. A computer readable medium containing executable computer program instructions, which when executed by a data processing system, cause the data processing system to perform a method, comprising:
displaying a word of a first language on an information display; and
displaying on the information display, a first translation of the word of the first language into a second language proximate to the word of the first language, wherein the first translation of the word is displayed in a first color which is different from a color used to display the word.

8. Said computer readable medium as set forth in claim 7, wherein the first translation of the word into the second language is displayed beneath the word of the first language.

9. Said computer readable medium as set forth in claim 7, wherein the first translation of the word into the second language is displayed above the word of the first language.

10. Said computer readable medium as set forth in claim 7, wherein the word of the first language contains letters.

11. Said computer readable medium as set forth in claim 7, wherein the word of the first language contains numbers.

12. Said computer readable medium as set forth in claim 7, wherein a second translation of the word of the first language into the second language displayed beneath the first translation of the word of the first language.

13. Said computer readable medium as set forth in claim 12, wherein the second translation of the word is displayed in a second color chosen to indicate a lower probability of translation accuracy than achieved with the first translation.

14. Said computer readable medium as set forth in claim 12, wherein the method further comprises:
selecting between the first translation and the second translation of the word, wherein only a translation selected remains displayed.

15. Said computer readable medium as set forth in claim 7, wherein a context of the word is used to increase a probability of achieving high translation accuracy.

16. An apparatus to display a language translation, comprising:
means for displaying a word of a first language on an information display; and
means for displaying on the information display, a first translation of the word of the first language into a second language proximate to the word of the first language, wherein the first translation of the word is displayed in a first color which is different from a color used to display the word.

17. Said apparatus of claim 16 further comprising:
means for displaying a second translation of the word of the first language into the second language beneath the first translation of the word of the first language.

18. Said apparatus of claim 16, wherein the first translation of the word into the second language is displayed beneath the word of the first language.

19. Said apparatus of claim 16, wherein a context of the word is used to increase a probability of achieving high translation accuracy.

20. An apparatus to display a language translation, comprising:
a processor;
a memory to communicate with said processor;
a display driver to communicate with said processor, wherein said apparatus to arrange a word of a first language and to arrange a first translation of the word of the first language into a second language to be displayed proximate to the word of the first language, wherein the first translation of the word is displayed in a first color which is different from a color used to display the word.

21. Said apparatus of claim 20, further comprising an information display, wherein the word of the first language and the language translation of the word into the second language are displayed thereon.

22. An apparatus to display a language translation, comprising:
a processor;
a memory to communicate with said processor;
a computer readable medium coupled with said processor; and
a process to display a language translation executed from said computer readable medium by said processor, wherein said process to display a word of a first language on an information display and to display, on the information display, a first translation of the word of the first language into a second language proximate to the word of the first language, wherein the first translation of the word is displayed in a first color which is different from a color used to display the word.

23. Said apparatus of claim 22, further comprising an information display.

24. Said apparatus of claim 22, wherein the first translation of the word into the second language is displayed beneath the word of the first language.

25. Said apparatus of claim 22, a second translation of the word of the first language into the second language displayed beneath the first translation of the word of the first language.

26. Said apparatus of claim 22, wherein a context of the word is used to increase a probability of achieving high translation accuracy.
